(19) United States
(12) Patent Application Publication
(10) Pub. No.: US 2025/0160237 A1
(43) Pub. Date: May 22, 2025

(54) Working tool reciprocation mechanism for agricultural machines

(71) Applicant: PEK AUTOMOTIVE D.O.O., Logatec (SI)

(72) Inventor: Mikhail KOSTKIN, Vrhnika (SI)

(21) Appl. No.: 18/729,509

(22) PCT Filed: Jan. 17, 2022
(86) PCT No.: PCT/IB2022/000002

§ 371 Date: Jul. 17, 2024

(51) Int. Cl. A01B 63/24; A01B 63/30

(52) U.S. Cl. CPC A01B 63/245; A01B 63/30

(57) ABSTRACT

The invention relates to mechanisms used for propelling various working tools of agricultural machines. The mechanism includes a beam having at least three support surfaces and a platform with a working tool capable of moving along the beam on rollers rotatably mounted on the platform. Moreover, a tooth rack is rigidly attached to the beam with its teeth capable of interacting with a cogwheel mounted on the platform and shaped as a disk with bearings acting as the teeth of the gear. Besides, at least two support surfaces of the beam are oriented at an angle to the horizontal and perpendicular to the direction of rollers travel, with at least three rollers interacting with the support surfaces of the beam. This design enhances the operational reliability of the mechanism under various loads experienced by the working tool during its operation.

### FIELD OF INVENTION

The invention relates to mechanisms used for propelling various working tools of agricultural machines.

### PRIOR ART

There exist various designs of reciprocation mechanisms, including those used on agricultural machines.

For example, patent KR20210002232 “Rack and Roller Pinion”, publication date 2021 Oct. 27, ICL F16H-019/04, describes a power transmission mechanism, which uses a rack and roller pinion for converting rotary motion into a linear one in various mechanical devices. The mechanism includes a tooth rack and a pinion with a plurality of rollers capable of rolling over the teeth of the pinion.

Patent KR20150081850, publication date 2015 Jul. 15, ICL A01B-049/00, describes an agricultural tilling machine. Said machine contains two parallel horizontal beams, along which a platform carrying a tilling mechanism travels. The platform is driven along the beams by means of a rack and pinion mechanism installed on one of the beams.

Patent EP2887789, publication date 2015 Jul. 1, ICL A01B-063/00, is known, which describes the design of an agricultural mechanism equipped with several agricultural tools. All the tools are mounted on one beam equipped with a tooth rack, and are capable of moving along the tooth rack independently of each other. Each tool has a pinion, which adjusts its position on the beam by interacting with the tooth rack. Also, each tool has a roller running along the upper support surface of the beam to make the tool's travel along the beam possible.

The above design is the closest analog to the case in point.

### DISCLOSURE OF INVENTION

The technical result achieved by the present invention consists of improving the operational reliability of the mechanism under varying loads experienced by the working tool during the agricultural machine operation.

The agricultural working tool reciprocation mechanism includes a beam with at least three support surfaces and a platform carrying a working tool and capable of traveling along said beam on the rollers that the platform is equipped with to permit its travel along the support surfaces of the beam. Moreover, a tooth rack is rigidly attached to the beam with its teeth capable of interacting with a cogwheel mounted on the platform and shaped as a disk with bearings acting as the teeth of the gear. Besides, at least two support surfaces of the beam are oriented at an angle to the horizontal and perpendicular to the direction of rollers travel, while at least three rollers are capable of interacting with the support surfaces of the beam.

Such a design improves the operational reliability of the mechanism under varying loads experienced by the working tool during the agricultural machine operation; furthermore, it enables the use of the described mechanism with agricultural machines having externally attached working tools.

In particular, the beam can have four inclined support surfaces oriented at an angle to the horizontal, with the upper surface having two support surfaces opposite to each other and, similarly, the lower surface of the beam having two support surfaces opposite to each other.

Moreover, one side of the beam can have two converging support surfaces oriented at an angle to the horizontal and perpendicular to the direction of rollers travel and forming a depression, with said depression housing at least one roller having raked surfaces enabling its interaction with the tilted support surfaces of the beam. Whereas, the other side of the beam has a surface that supports a roller rotatably fixed on the platform and capable of traveling along said surface of the beam.

Finally, one of the support surfaces of the beam can support at least two rollers fixed on opposite sides of the cogwheel.

The bearings of the cogwheel can be mounted on pins

### BRIEF DESCRIPTION OF DRAWINGS

FIG. 1 shows the reciprocation mechanism with rollers interacting with the support surface of the beam.

FIG. 2 gives a sectional side view of the reciprocation mechanism.

FIG. 3 shows a tooth rack with a cogwheel shaped as a disc with bearings.

FIG. 4 gives a sectional view of the cogwheel across A-A.

FIG. 5 presents another embodiment of the mechanism with two converging support surfaces.

FIG. 6 gives a side view of another embodiment of the mechanism with two converging support surfaces.

FIG. 7 shows an embodiment of the mechanism having a ripper as a working tool.

FIG. 8 shows an embodiment of the mechanism with two mowers mounted on a single support beam.

FIG. 9 shows an embodiment of the beam with support surfaces for accommodating two mowers

### EMBODIMENTS OF THE INVENTION

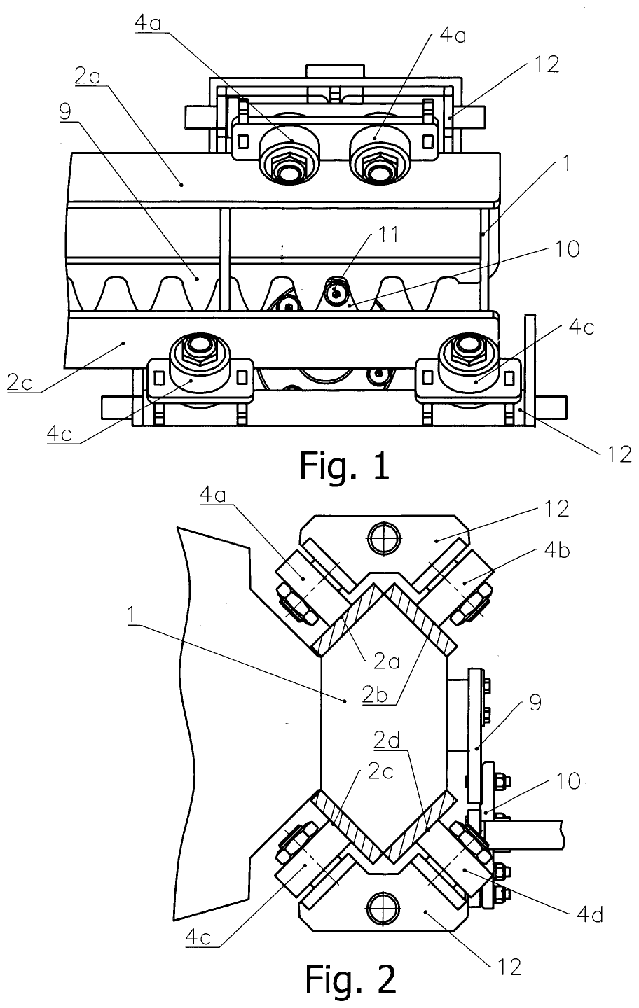

The working tool reciprocation mechanism for use on agricultural machines (FIG. 1-FIG. 2) in its first version includes a beam 1 with four support surfaces 2-2a, 2b, 2c, 2d, wherein the upper surface of the beam 1 (FIG. 2) has two support surfaces 2a, 2b located opposite to each other, and the bottom surface of the beam 1, similarly, has two support surfaces 2c, 2d opposing each other. At the same time all the support surfaces 2-2a, 2b, 2c, 2d of the beam 1 are oriented at an angle to the horizontal and perpendicular to the direction in which the rollers 4-4a, 4b; 4c, 4d 4 travel along the support surfaces 2. In this embodiment, the support surfaces 2 are oriented at 45° to the horizontal. The beam 1 in this embodiment has an increased strength, and its support surfaces 2 provide a firm support for the platform 3 carrying any type of agricultural working tool.

The corresponding support surfaces 2-2a, 2b, 2c, 2d of the beam 1 enable the movement of the rollers 4-4a, 4b and 4c, 4d installed in carriages 12 that are fixed on the platform 3 capable of traveling along the beam 1.

The beam 1 in this embodiment has an increased strength and its support surfaces 2 provide a firm support for carriages 12 of the platform 3, on which the agricultural working tool is installed.

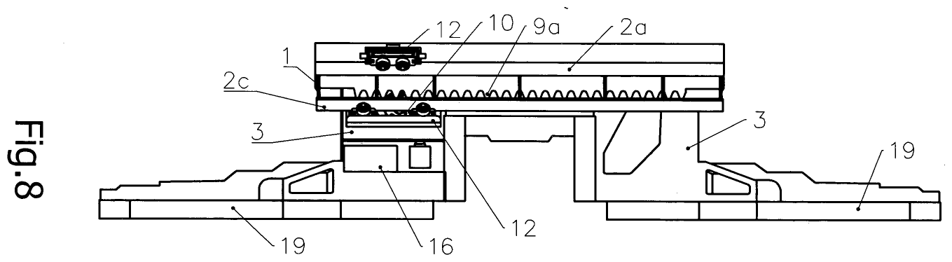

An example of how the reciprocation mechanism of this embodiment operates with a ripper 15 as the working tool is shown in FIG. 7. The working tool represented by the ripper 15 is driven by the motor 16 through corresponding rotation transmission mechanisms. The Figure also shows the drive mechanism 14 for moving the platform 3 along the beam 1. The drive mechanism 14 includes a motor (not shown in the Figures), which makes the rack and pinion gear 10 rotate.

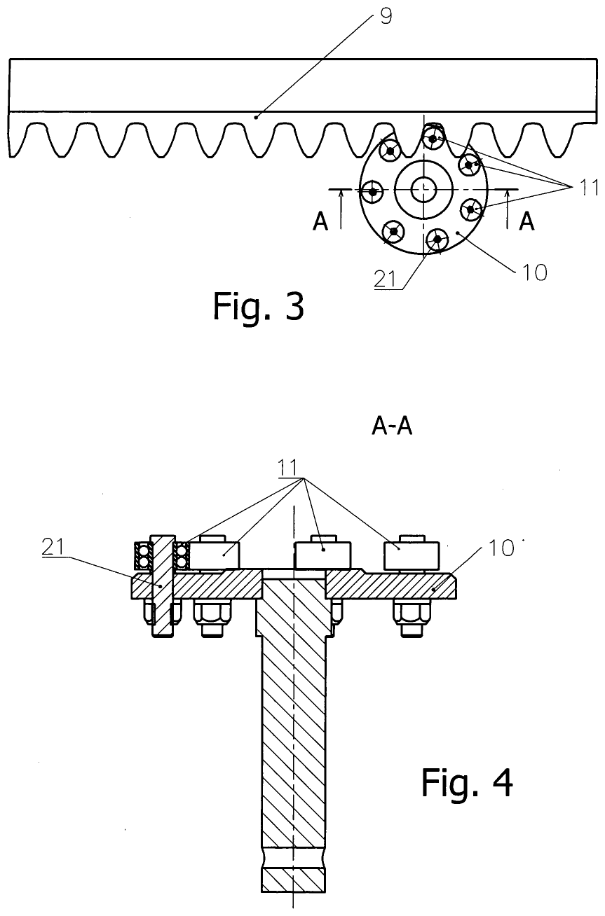

The rack and pinion used in this embodiment of the reciprocation mechanism is shown in FIG. 3, FIG. 4. It contains a tooth rack 9 with its teeth capable of interacting with the cogwheel 10 mounted on the platform 3 and shaped as a disk with ball bearings 11 that do not require maintenance and act as the teeth of the cogwheel 10. Each bearing 11 is mounted on a pin 21 of the cogwheel 10. The use of bearings 11 reduces the shock load on the teeth of the tooth rack 9 and lowers the noise generated by the reciprocation mechanism operation.

The operation of this reciprocation mechanism embodiment can be illustrated with an example of how the device shown in FIG. 7 works. The platform 3 moving along the beam 1 is driven by the motor 14 mounted on the platform 3. The direct and reverse rotation of the cogwheel 10 makes the bearings 11 roll over along the tooth rack 9, thus driving the platform travel along the beam 1, with its rollers 4 rolling along the support surfaces 2. The working tool itself, represented by the ripper 15, is driven by a separate motor 16 through appropriate transmission mechanisms.

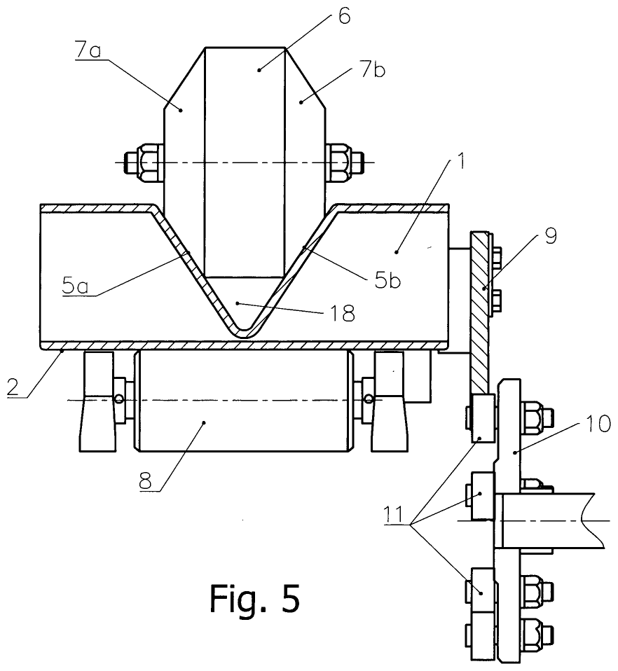

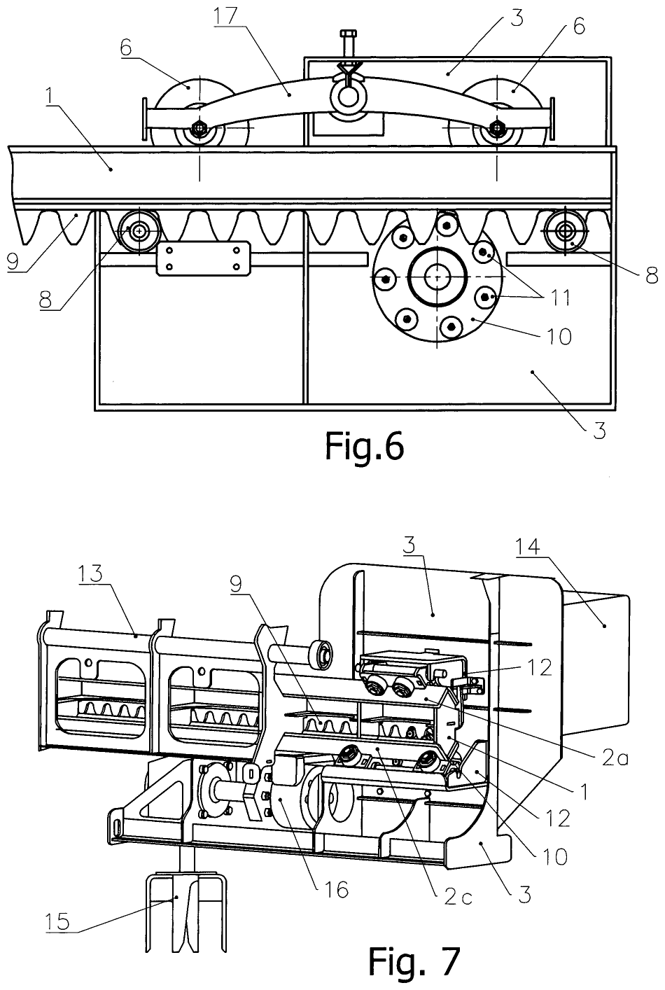

Another embodiment of the reciprocation mechanism described in this invention is shown in FIG. 5, FIG. 6. One of the surfaces of the beam 1—the upper surface in this particular case—has two converging support surfaces 5a, 5b (FIG. 5), oriented at an angle to the horizontal and perpendicular to the direction of the travel of the rollers 6, with said surfaces forming a depression 18. The resulting depression 18 holds at least one roller 6 having raked surfaces 7a and 7b, which interact with the support surfaces 5a, 5b of the beam 1. The most robust version of this embodiment contains two rollers 6 (FIG. 6). Besides, a horizontal surface 2 is arranged on the surface of the beam 1 (FIG. 5), along which the support rollers 8 (FIG. 5, FIG. 6) travel. The rollers 6 with raked surfaces 7 are installed in carriages 17. The reciprocation of the carriages 17 mounted on the platform 3 is driven by the cogwheel 10 mounted on the platform 3 and shaped as a disk with bearings 11, which interact with the teeth of the tooth rack 9. The above mechanism operates almost in the same manner as the previous embodiment. The only difference is that the rollers 6 move along the converging support surfaces 5a, 5b of the beam 1. Such a design makes the embodiment more compact and ensures its operational reliability under various loads experienced by the working tool.

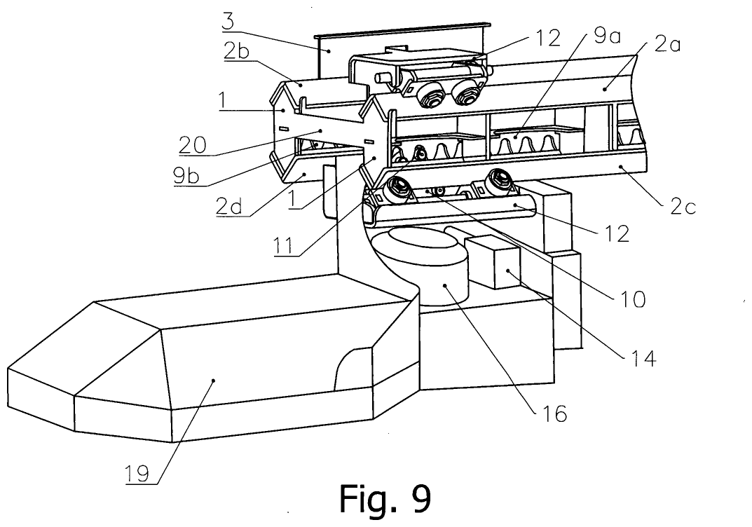

One more embodiment of the invention is shown in FIG. 8, FIG. 9. Here, two reciprocation mechanisms are mounted on a composite beam 20. The beam 20 (see FIG. 9) consists of two rigidly interconnected beams 1, each of which has tooth racks 9a and 9b. A separate carriage with rollers 4 moves along the support surfaces 2 of each beam. FIG. 8 and FIG. 9 show the first version of the reciprocation mechanism, though a differently designed one can be applied. The presence of two reciprocation mechanisms on one composite beam 20 makes the agricultural machine more compact and provides for a simultaneous operation of tools located on both sides of the machine. In this embodiment, the working tools installed on the platforms 3 are represented by mowers 19 driven by motors 16.

### INDUSTRIAL APPLICABILITY

The design of the reciprocation mechanism can be applied to different types of agricultural machines as basic or attachable equipment. Also, it can be used when cultivating soil both within the agricultural machine clearance limits and beyond them, for example, when tilling in row spacing.

1. A working tool reciprocation mechanism for an agricultural machine, the mechanism comprising:
a beam with at least three support surfaces and a platform carrying a working tool and capable of moving along the beam on rollers, which are mounted on the platform and configured to roll along the support surfaces of the beam;
wherein the beam comprises a tooth rack rigidly attached to the beam, the teeth of the rack are capable of interacting with a cogwheel mounted on the platform and shaped as a disk with bearings acting as teeth of the cogwheel, and wherein at least two support surfaces of the beam are oriented at an angle to the horizon and perpendicularly to a direction of motion of the rollers, and wherein at least three rollers are capable of interacting with the support surfaces of the beam.

2. The mechanism according to claim 1, wherein the beam comprises four inclined support surfaces oriented at an angle to the horizon, wherein an upper surface of the beam comprises two support surfaces opposite to each other and a lower surface of the beam comprises two support surfaces opposite to each other.

3. The mechanism according to claim 1, wherein one of the surfaces of the beam has two converging support surfaces oriented at an angle to the horizon and perpendicularly to a direction of motion of the rollers, thus forming a depression, the depression holding at least one roller with raked surfaces that are capable of interacting with the support surfaces of the beam set at an angle to each other.

4. The mechanism according to claim 3, wherein the beam comprises a horizontal surface enabling motion of a supporting roller rotatably mounted on the platform.

5. The mechanism according to claim 1, wherein one of the support surfaces of the beam supports at least two rollers located on opposite sides of the cogwheel.

6. The mechanism according to claim 1, wherein the bearings of the cogwheel are mounted on pins.
